(19) United States
(12) Patent Application Publication
(10) Pub. No.: US 2006/0259232 A1
(43) Pub. Date: Nov. 16, 2006

(54) System for monitoring vehicle and airplane traffic on airport runways

(76) Inventors: Virginia Lorraine Huthoefer, Diamondhead, MS (US); Gerald Wallace Huthoefer, Diamondhead, MS (US)

Correspondence Address: MICHAEL D. CARBO, SUITE 700, 228 ST. CHARLES AVENUE, NEW ORLEANS, LA, 70130, US

(21) Appl. No.: 11/127,672

(22) Filed: May 12, 2005

(51) Int. Cl. G06G 7/76

(52) U.S. Cl. 701/120; 342/36

(57) ABSTRACT

An airfield runway occupancy warning system includes inductive loops buried in a runway proximate to an intersection of said runway and a taxiway. Other inductive loops are buried in a taxiway proximate an intersection of the taxiway and a runway. A communication system receives data from each of the inductive loops and transmits the data to at least one monitoring device.

### CROSS-REFERENCE TO RELATED APPLICATIONS

This application is a continuation in part of United States Nonprovisional Patent Application Ser. No. 60/449,052, filed on Feb. 20, 2004, which application is pending.

### STATEMENT REGARDING FEDERALLY SPONSORED RESEARCH OR DEVELOPMENT

None

### REFERENCE TO SEQUENCE LISTING, A TABLE, OR A COMPUTER PROGRAM LISTING COMPACT DISK APPENDIX

None

### BACKGROUND OF THE INVENTION

1. Field of the Invention

This invention relates to a system for monitoring vehicle and airplane traffic on airport runways through the use of inductive loop sensors and more particularly, to a system that provides communication between airfield inductive loop sensors and other airfield equipment such as signage and lighting systems and that also feeds data to a tower-based controller interface.

2. Description of the Related Art

Rising air traffic is straining aviation safety at airports around the world, requiring improved safety measures to prevent accidents on congested airport runways. With most aviation accidents occurring on the ground during aircraft take-offs and landings, the focus of current safety policy is to improve detection and prevention of runway incursions. Past reliance on purely human abilities to visually maintain safe aircraft separation and prevent ground incursions is shifting to increasing integration of technological solutions.

Studies show that airline traffic is increasing every year. The FAA projects aircraft operations (take-offs and landings) at its facilities to rise by 25 percent over the next ten years, from 45.7 million in 2000 to 59.4 million in 2011. Further, the number of passengers arriving on foreign flag air carriers is expected to rise from 137.6 million to 239.4 million by 2011, an increase of 85 percent. The growth in passengers will lead to larger fleets of air transport category (60 or more passenger capacity) aircraft operating worldwide. The Boeing Aircraft Company projects that the number of these larger aircraft operating worldwide will more than double from 11,066 in 2000 to 23,081 by 2011. The increase in aircraft operations will inevitably lead to more aircraft incidents and accidents, with studies suggesting that losses of these large aircraft will double by 2015.

The FAA records three types of runway incursions: Operational Errors (OE), Pilot Deviations (PD), and Vehicle/Pedestrian Deviations (VPD). An Operational Error occurs when an air traffic controller inappropriately clears an aircraft into a situation that results in a collision hazard. A Pilot Deviation occurs when a pilot moves an aircraft into a position, without air traffic control approval, that leads to a loss of separation. A Vehicle/Pedestrian Deviation occurs when a vehicle or individual enters a runway without air traffic control approval that leads to a collision hazard. All three of these categories are based on human error and a loss of appropriate separation between an aircraft and/or a vehicle. According to the FAA, the number of runway incursions in the United States grew from 187 in 1988 to 339 in 2002. This represents more than an 80-percent in 14 years.

Radar-based systems currently in use today include Airport Surface Detection Equipment-3 (ASDE-3) and Airport Movement Area Safety System (AMASS). These systems are expensive and offer limited deployment options in that only facilities that are radar-equipped can adapt a radar-based ground system. This costly requirement effectively eliminates the majority of the airports worldwide. Further, it has been documented that the largest share of runway incursions are attributed to errors made by general aviation pilots, flying aircraft in and out of small- and medium-sized airports.

ASDE-3

In development since the early 1980's, the FAA is now installing this radar system to help controllers monitor movement of aircraft and ground vehicles on the airport surface during low or no visibility conditions. The FAA has purchased 40 ASDE-3 systems that will service 34 airports at a total cost of $250 million, or $7 million per system.

ASDE-3/AMASS

AMASS is a software/hardware application that builds on the ASDE-3 radar information by providing visual data (identity) information and audible warning systems to alert air traffic controllers that a runway incursion is pending. An FAA spokesperson identified the ASDE-3/AMASS system as the most significant technical effort on preventing near collisions. The NTSB, however, has expressed concern that “the AMASS system's current audible and visual alert parameters may not provide controllers and/or flight crews sufficient time to react and intervene to maintain safe separation.”

The ASDE-3 and AMASS systems are not only expensive to procure, but the data they provide are often too complex for a timely response by the controller. More importantly, ASDE-3 and AMASS do not provide any benefit to the rest of the air traffic system. The NTSB has expressed concern about the limited deployment of ASDE-3 and AMASS combination with service to only 34 airports nationwide. The dual system, at a cost of at least $9 million per airport, is too expensive to implement nationwide at the other 430 small- and medium-sized airports with air traffic control towers. Because of the cost, the FAA cannot provide ASDE-3 and AMASS to the very airports where they may be needed most. In many cases, small airports utilized by less-experienced air taxi and general aviation aircraft face a higher incidence of runway incursions. Consequently, individuals who utilize these small airports and make up the majority of aircraft operations (take-offs and landings) on a daily basis have become the “have-nots” in terms of a runway incursion solution.

### SUMMARY OF THE INVENTION

An alternative to radar-based solutions is a system based on traffic signal technology. This approach creates a network of inductive loops that are installed directly into airport runways and taxiways. The system of the present invention, trademarked ROWS™, serves as both a controller and a pilot aid. The air traffic controller will monitor runway activity at taxiway hold short and takeoff points through a display panel located in the air traffic control tower. Approaching flight crew will be alerted to potential runway obstructions through modifications to existing lighting systems (PAPI/VASI); and flight crew on the ground will be alerted to runway status through a variable message sign board subsystem (VMS) that also will list selected environmental sensor data (wind, altimeter, density altitude readings). The ROWS system also has the capability to track velocity on takeoff, as well as to provide speed data to taxiing aircraft and communicate this information to the pilot through a VMS message. In-ground light-emitting diodes (LEDs) will reinforce flight crew positional awareness at hold short thresholds. The passive, warning-only system of recessed lights embedded in the runway at hold short lines will alert flight crew of an occupied runway. There will not be any indications to proceed by such a lighting system. The red lights will activate when a target enters an active runway zone.

The system of the present invention provides for specific setup configurations to serve operational requirements during periods of high- and low-density air traffic at landing facilities both staffed and non-staffed with air traffic control personnel. Through the use of a touch-screen or optional heads-up display, the configuration of the airport runway/taxiway layout will illuminate all intersection, critical point, and blind spot locations that are equipped with sensors. The controller will have total control over the alert algorithm. The presence of metallic object in any of these areas will be communicated to the controller through a choice of customized visual and/or audible notifications. Tower personnel can select or deselect sensor grids based on the level of alert required for maximum operational safety and adjust sensor sensitivity (time-delay) sequences as appropriate to eliminate unnecessary obstruction warnings, and adjust both the tone and pattern of the audible alarm.

Further, ROWS sensing devices for airport runways have applications beyond the control tower. The flight crew of aircraft on final approach can utilize information received from the sensing network. Airport surface subsystems using the ROWS' loop network include existing lighting systems (VASI/PAPI) modified to sensor inputs to alert flight crews on final approach of potential runway obstructions. Additionally, the system of the present invention provides information to taxiing aircraft via addressable message signboards and embedded LEDs. Sign board messages can include airport environmental sensor data such as wind/altimeter and density altitude updates and runway status information such as “runway closed,” and “runway occupied.” Through velocity calculations, sensor logic will alert controller personnel of aircraft deceleration or acceleration on takeoff, and through messages on addressable message boards, alert speeding aircraft on taxiways to “reduce speed.” Currently, the primary warning system to alert flight crews of runway obstacles at most locations is controller notification or the flight crew's ability to see potential problems. In-ground light-emitting diodes (LEDs) will reinforce flight crew positional awareness at hold short thresholds. A passive, warning only system of recessed lights embedded in the runway at hold short lines will alert flight crew of an occupied runway. There will not be any indications to proceed by such a lighting system. The LEDs will illuminate red at the hold short line when any target enters an active runway zone. Finally, speed regulation also will be controlled through the installation of “speed bumps” on airfield taxiways.

The system of the present invention makes operational and economic sense. The per unit cost of the system is significantly less than the cost of an ASDE-3 system, enabling installation at many locations rather than a select few. The design of the present system is scalable to any airfield configuration. Its compartmentalized design enables easy component “plug-in and perform,” cutting down on maintenance and repair costs and allowing easy installation at all airport facilities.

In summary, the system of the present invention provides a simple, low-maintenance, low-cost, effective, all-weather runway incursion warning system scalable to any size airport facility, whether or not the facility is radar-equipped. Most significantly, it is an affordable solution for the primary cause of runway incursions—pilot deviations by general aviation pilots—that occur at all airports, but which are particularly common at small- and medium-sized airport facilities.

### BRIEF DESCRIPTION OF THE SEVERAL VIEWS OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a drawing of a system architecture that is representative of the functionality of the system. Designs can vary for each installation.

FIG. 2 illustrates ROWS' High Level System Interrelations

FIG. 3 is a flow chart of the Variable Message System

FIG. 4 is a flow chart of the location triggering process

FIG. 5 is a flow chart of the Air Traffic Controller Choice Process

FIG. 6 is a flow chart of the Location-delay process;

FIG. 7 is a flow chart of the Volume Regulation Process

FIG. 8 is a flow chart of the Velocity Calculation Process

FIG. 9 is a flow chart of the Pilot Visual Lighting Notification Process

FIG. 10 is a flow chart of the Runway/Taxiway Selection Process

FIG. 11 is a cutaway of the in-ground installation of the loops,

FIG. 12 is an example of a warning code for use with the disclosed system, and

FIG. 13 is a schematic plan view an inductive loop.

### DETAILED DESCRIPTION OF THE INVENTION

Inductive loop technology has been used throughout the world's roadways to control automobile traffic-by-traffic lights calibrated to sense vehicles waiting for the light to change. Once the inductive loop field is violated, a specific time is allotted for the car to wait before the light changes and the automobile can proceed. This technology has not previously been used in an airport environment to keep the controller apprised of traffic conditions on the runways and to trigger airfield lighting systems for taxiing vehicles and airplanes as well as approaching aircraft.

The runway obstruction warning system disclosed herein overcomes the problems associated with prior art systems by providing a low-maintenance, low-cost, effective, all-weather runway incursion warning system scalable to any size airport facility, regardless of whether the facility is radar-equipped or even staffed by air traffic personnel. Although comprehensive surface surveillance systems offer practical technology enhancements for large airports, these systems cannot be cost-justified for smaller airports. The disclosed system uses a computer monitored inductive loop sensing and lighting system to limit runway accidents and incursions. The disclosed system can be used alone or in combination with other systems to augment more comprehensive surveillance solutions.

By placing loop grids at intersections of taxiways and runways, and monitoring the readings through instruments located in the control tower, controllers will maintain a visual picture of traffic in the airport's movement area, receiving clear, concise runway status information in both good and inclement weather. The specific placement of the loops on the grid can be determined based on each airport's operational requirements. The loop placement is not limited to runways, but can include taxiways, blind spots, etc. The use of airport surface alerts through embedded LEDs, VMS, and modifications to existing lighting systems (PAPI/VASI) at the runway/taxiway intersections and runway entrances provide pilots, as well as ground vehicle drivers, real time status conditions of the runway.

The system provides timely and easy to understand shared data to all air traffic personnel in the tower and aircraft flight crew on final approach, both taking off and landing, permitting a common situational awareness of the surveillance picture at all times. The system provides for specific setup configurations to serve operational requirements during periods of high- and low-density air traffic. Tower personnel can select or deselect sensor grids and adjust sensor sensitivity (time-delay) sequences as appropriate to eliminate unnecessary obstruction warnings.

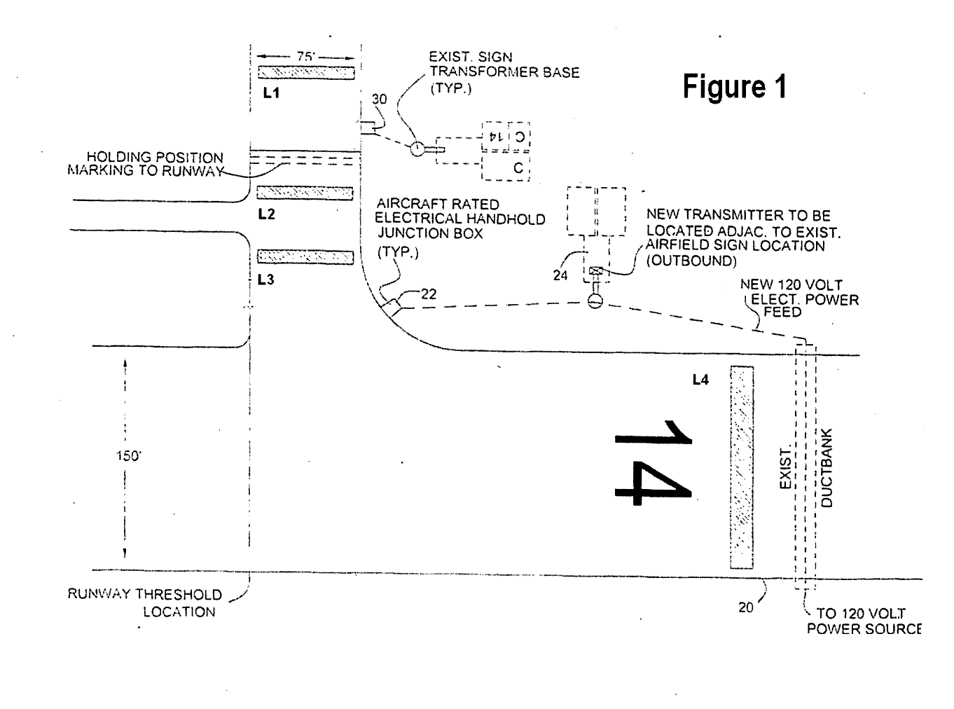

FIG. 1 illustrates a client/server application having four (4) distinct subsystems; the field loop sensors L1, L2, L3, and L4, a signal relay station, and the communications and management control subsystems. The system architecture takes into consideration the requirement for a fault tolerant design. Examples of faults in an airway application would include, but not be limited to, loop faults (e.g., breakage of wire); sending/receiving unit faults (malfunction loss of power, etc.); and loop detector faults (malfunction, loss of power). Examples include: loops faults (e.g. breakage of wire); sending/receiving unit faults (malfunction loss of power, etc.); and loop detector faults (malfunction, loss of power).

Detector System

FIG. 1 illustrates system architecture. Inductive loops L1-L4 are placed in such a way that a “trap grid” is created. In the illustrated embodiment, each loop L1-L2 has a length of about 64 feet, which is sufficient to span the width of the taxiway, and a width of 6 feet. Each loop L3-L4 has a length of about 140 feet, which is sufficient to span the width of the runway 14 and a width of 6 feet. The width is determined by what is desired to be the optimum coverage area of each loop field. In this example, each loop emits a 10-foot electromagnetic field and therefore a 20-foot loop field. The loop widths can vary based on the size of the target obstacles (e.g., airplane vs. automobile). Depending upon the application, the loops can be varied in width and length and the applicable loop dimensions will be evident to one skilled in the art when read with the disclosure herein. Maintaining the loops of equal size does, however, provide the advantage of economies of scale in production and easier installation. However, each design can be customized to the particular application and can include loops of different sizes, based on the needs of each airfield's configuration and operational requirements.

The trap grids can detect the entry of aircraft/vehicles through loops L1 and L3. Crossing of these two loops transmits an alert to the tower interface that an obstruction is in place. Alert status turns off after crossing loops L2 and L4. Aircraft entering trap grids in opposite direction will be detected in an opposite logical pattern, with loops L4 and L2 serving as entry detection points, and loops L3 and L1 serving as exit detection points.

In the preferred embodiment, the loops are located at all taxiway/runway intersections, and runway entrances and the placement and number will vary from airport to airport, based on each airport's operational requirements.

Although in general use, the loops can be placed across the runways, as illustrated in FIG. 1, the placement of the loops along the plane's pathway, as indicated in FIG. 1, also enables the system to be programmed to trace the speed of the plane as it passes over each loop.

Inductive Loop Technology

The inductive loop is an insulated electrical wire with several turns. Loops are installed in a variety of shapes such as square, rectangle, round, diamond, circular and octagonal, though each configuration produces a different electromagnetic field. Most inductive loops are formed by wrapping a single wire strand around the loop shape a prescribed number of times. Ruggedized, weather resistant pre-formed loops are available to aid in uniformity leading to improved reliability.

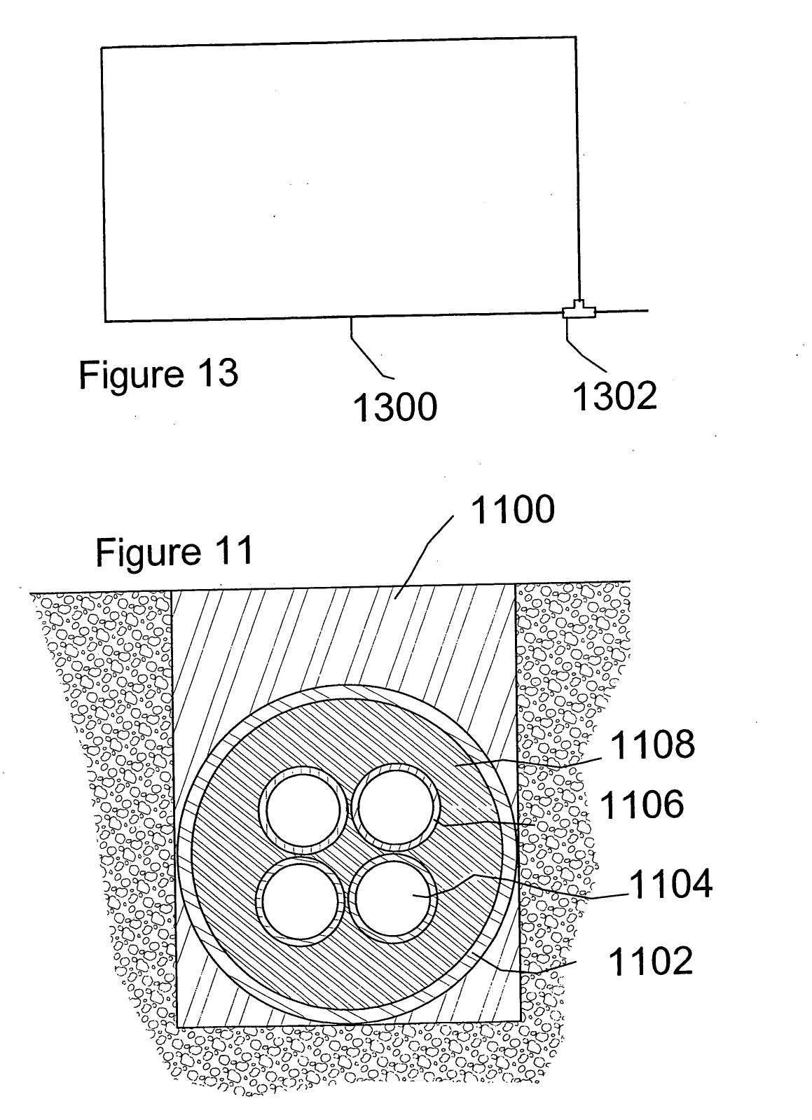

As a rule, Inductive Loop Detectors, or ILDs are placed either on top or up to twenty (20) inches below the road surface, as illustrated in FIG. 11. Pre-formed inductive loops (PILDs) have been designed for cut-in installation into hot asphalt or under asphalt or concrete overlays in order to extend the loop's life span. While deep buried loops may exhibit a longer life span, their electromagnetic field above the road's surface is weaker and detection becomes more difficult. Loop sensitivity, defined as the smallest change in inductance which will cause actuation, decreases around 5% for every inch into the pavement the loop is installed. Unless loops are installed during road construction, installation requires a saw cut, up to 16 mm wide, into the pavement.

Conventional loop systems use unprotected strands of common copper wire with a thin insulation jacket. These types of loops have a high failure rate and are subject to breakage and malfunction in a harsh weather and traffic environment. The disclosed preformed inductive loop detectors (PILDs) are much more resistant to typical faults and consequently, last much longer. The specifications for the preferred loop are:

CG16MMA

ASPHALT PAVE OVER PREFORMED INDUCTIVE LOOP
FUNCTION: Traffic Detection
Conduit:
>> Highly abrasion-resistant Polyurethane cover
>> High tensile strength braided synthetic fiber reinforcement
>> Good flexibility over a wide temperature range
>> Minimum burst pressure of 9,000 psi (62,050 kPa)
>> Polyester core tube
>> Max. o.d. of ⅝″ (16 millimeter)
Connection: Loop head to loop lead-in
>> High tensile strength Polyvinyl carbonated “T” connector to connect
the loop head to the protected lead-in
Wire:
>> Loop wire is 16 gauge tffn/thhn stranded single conductor.
>> Number of wire turns to be determined by engineer or factory and will
depend on, loop size, loop depth and special factors.
>> Lead-in wires are machine twisted at a minimum of 4 twists per foot
(30 cm).
>> One continuous wire is used in order to manufacture the loop and
lead-in. No splices are used.
Miscellaneous:
>> ENTIRE loop AND lead is filled with a flexible rubber asphalt
emulsion to: (a) prevent moisture entering the conduit (b) prevent false
calls due to movement of the wire within the conduit.

Prior art loop systems pass magnetic field signals from the ILD to an Electronic Loop Detector (ELD). The ELD interprets and passes the magnetic field reading to the transmitter. Standard ELDs are programmed to read ILD signals in the 50 to 2500 microhenry range. This is accomplished through the use of a governing device in the electronics of the ELD that limits readings to this range. This range provides the most accurate reading of the magnetic field in a typical automobile traffic environment using standard size ILDs.

Inductive loop systems for airport movement areas employ loops that are much larger than ones used in traditional traffic systems. One of the effects of using longer loop lengths is that signals frequently will extend beyond the upper limit of the acceptable range of 50-2500 microhenries. Readings outside of this range will produce a higher incidence of false signals due to increased variation in the signal. To solve this problem, the disclosed system utilizes a modified ELD. The ELD for aviation applications has the governing device removed, and in its place, a diode is added that can smooth out the higher signal range so that it can be read accurately.

The information provided by the inductive loops is fed into a junction box, or pull box 22 that feeds into the loop detector and subsequently to the transmitter 24 through use of a wire or wireless connection. The pull-box 22 is usually located adjacent to the runway and houses the splices between the lead-in cable from the detector enclosure 24 and the lead-in wires from the loops. Although the junction box 22 and the transmitter 24 are illustrated, in this figure, at separate locations, the junction box and transmitter can be a combined unit. When the junction box 22 and transmitter 24 are separate units, there is a maximum distance of separation that, dependent on the size of the loop and the loop output, will be evident to those skilled in the art. Lead-in wires are preferably shielded and twisted to eliminate disturbances from external electromagnetic fields, such as adjacent loops. The transmitter 24 is connected to a power source through applicable methods known in the art.

As illustrated in FIG. 1, the loops L1 and L2 are placed to create a hold-short detection point on the taxiway. Although it does interact with the control tower, they are stand-alone and do not interact with the loop grids on the runway intersection. These loops can indicate to the tower the presence of an aircraft or vehicle at the hold short line, alerting the controller with a warning signal on the computer interface. Finally, loop L3 will trigger the PAPI/VASI lighting system to alert approaching aircraft of an obstruction on the runway.

Detectors operate in either the pulse or presence mode. Presence operation, often used with traffic signals, implies that detector output will remain “on” while a vehicle is over the loop. Pulsed detection requires the detector to generate a short pulse (e.g. 100 to 150 ms) every time a vehicle enters the loop, regardless of the actual departure of the detected vehicle. In the present system, the preferred method is the presence mode since the controller needs to be alerted to the presence of a vehicle at all times.

In the preferred embodiment digital detectors are used that sense a change in the resonant frequency of a loop due to a decrease in inductance, enabling more reliable and precise measurements. Some digital units incorporate advanced electronics such as self-tuning amplifiers, open-loop test functions, and automatic or remote reset capabilities, which can significantly reduce detector maintenance costs and calls. The newest detectors can output the digitally sampled inductance “signature” of each vehicle, facilitating the use of flexible signal processing software to add considerable more robustness than the hardwired set “threshold” detectors.

In order for the disclosed system to be sufficiently familiar for the air traffic controllers to use, the display had to be easy to use and be operable in a manner similar to current systems. To make the system easy to use, the monitor has an optional heads-up, or touch screen display in a Windows, or other familiar, format. To save time, all settings are preferably activated by either touch or with a point and click option through use of a mouse. The display configuration of the airport runway/taxiway layout preferably also includes a tool bar located at top or bottom of screen for user access to setting controls. The grids are displayed for all intersections on runways and should have commonly identifiable characteristics such as: red or yellow icons indicating an obstruction.

The system has the ability to be configured to the individual air traffic controller, although specific configurations as dictated by FAA operational procedures cannot be overwritten. Standard operating procedures in the air traffic control environment allow the individual to configure equipment (e.g., radar and radios) to personally preferred operational settings. The settings configured by the air traffic controller are saved, according to individual preferences, and activated at log in. The system can, however, be programmed to permit only unified settings to be used if so required.

The programming flexibility of the program permits the addition of any security enhancements that would, in the future, be required by the end user. Currently, access is through standard userid/password entry. The present system is compatible with all current security logins, such as retinal scans, fingerprint identification, key card, alphanumeric, etc.

All grids must be able to be configured individually in the time delay sequence desired by the user. The default time delays should be in small increments before the system indicates an alarm, although the system preferably provides an override to customize the delays. For safety reasons it is best to put a maximum delay that cannot be accidentally overridden by the user. User needs to be able to engage or inhibit sensor grids to desired configuration.

In some embodiments, in order to accommodate aircraft arrival and rollout on the runway, a 3-5 second delay will be built into the system to allow aircraft to roll through grid patterns without issuing an unecessary alarm. This is an alternative that can, if so desired, be included in all systems and either activated or deactivate based upon user choice.

It is important that the user cannot easily turn off the entire alarm system inadvertently, although the audible alarm can be set either on an individual basis or turned off completely. The user preferably has several options on the alarm sound, such as both voice and/or tone patterns. Voice options can include specific warnings such as “Runway Obstruction 14 at Alpha” for an obstruction that is occurring on runway 14 at taxiway A. Tone patterns can include a wide variety of alert signals, all with volume control.

The system software records all configuration settings and system performance on the hard drive for easy retrieval should an incursion or accident take place. The hard drive “save” feature can be configured to save information settings for a 24-hour period, or longer, with the ability to archive this information for an extended period. Additionally, the system is designed to enable rapid, system wide updates for the end user as required.

In addition to the information sent to the control tower, the flight crew of aircraft on final approach can utilize information received from the system through the use of modifications made to existing approach lighting, e.g., PAPI/VASI. The approach lights will activate a flashing or pulsing pattern once an aircraft taxies onto the runway and remain activated until the aircraft is airborne or exits an active runway. Once the aircraft is clear of the runway, the approach lighting switches back to its normal state, signaling any approaching aircraft that the runway is no longer occupied.

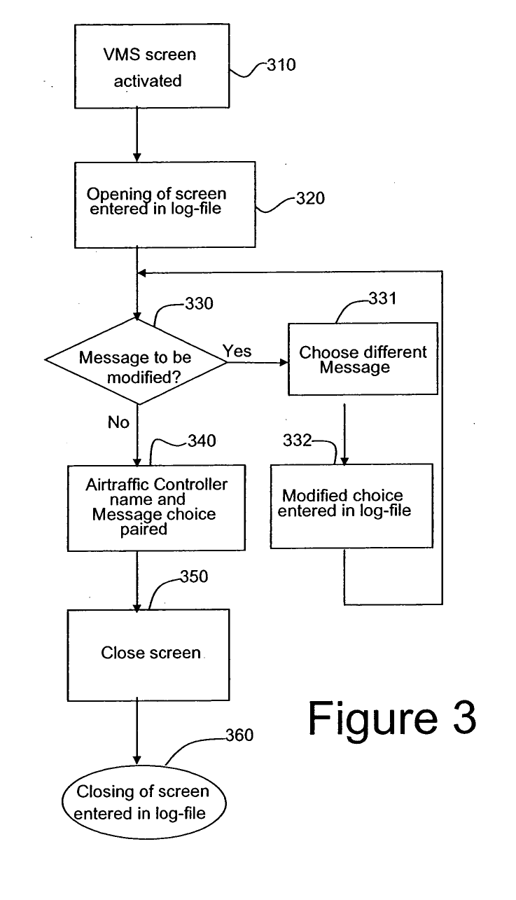

For flight crew on the ground, either taxiing to the gate or preparing for takeoff, the ROWS system will provide the capability to trigger pre-determined, discrete messages on addressable sign boards as indicated in FIG. 3. This system can generate messages automatically through sensor logic and will not involve air traffic personnel input. Such messages may include “runway occupied,” and “reduce speed.” In addition, the message boards can display selected airport environmental data automatically collected and transmitted from existing environmental condition sensors on the airport surface such as wind/altimeter information, and density altitude alerts, and will require no controller input.

However, these messages can be overridden by tower/airport personnel, as necessary, to meet airport operational requirements. For example, when a runway is closed due to construction and maintenance, the addressable sign board can be set to read “runway closed.” Another example of an override message could include current bird conditions such as low, moderate, or severe. Override messages will be accessed by the tower/airport personnel through a touch screen on the ROWS graphical user interface that will enable the individual to select a predefined set of messages for the affected runway. Again, there will be no controller instructions displayed or otherwise input into the system.

These messages can be triggered by sensors located at critical points on the runway such as the takeoff area, and at all taxiway entrances and hold short lines. It is thus seen that the ROWS system does not require a total encapsulation of the runway.

Software Hierarchy and Flow Logic

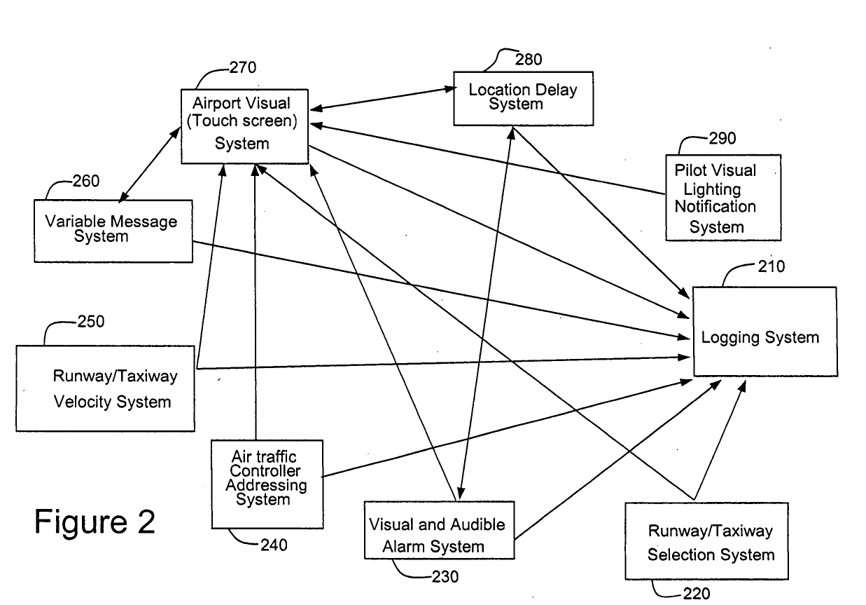

High Level System Interrelations, FIG. 2

This flowchart describes the total functions of the high level system which is comprised of the following subsets: a logging system 210, a runway/taxiway selection system 2.20, a visual and audible alarm system 230, a traffic controller addressing system 2.40, a runway/taxiway velocity system 250, a variable message system 2.60, an airport visual (touch screen) system 270, a location delay system 280, and a pilot visual lighting notification system 290.

The nine-subset systems have either a one-way or two-way interrelation. For example, the location delay system has a two-way interrelation between the logging system and the visualization on the screen in the tower. There is a two-way interrelation between the location delay system and the visual and audible alarm system. It can also be observed that seven of the subsystems report directly to the logging system.

All of these subsystems interrelate with each other as one complete unit. The system can be divided into two distinct applications: a controller aid and a pilot aid system. Whereas the controller aid subsystems are all located in the tower, the components, intelligence, and outputs of the pilot aid subsystems are located physically in the field and include the runway/taxiway velocity system, the pilot visual lighting notification system, and the Variable Message System (VMS).

Field Systems:

FIG. 3: Variable Message Systems (VMS) Process. Through the software application, the VMS screen 310 is activated. The opening of the screen is entered in the log file on the hard disk of the CPU 320. If the message needs to be modified, the air traffic controller (ATC) can choose a different message 331. The modified choice is entered in the log file 332. If the message is not to be modified, the ATC name and the message choice will be paired 340. The ATC closes the screen 350 and the closing of the screen is entered in the log file 360. It should be noted that logic is generated in the tower, but the message chosen by ATC appears on the message board in the field.

FIG. 8: Velocity Calculation Process. Detection grid/trap logic 810 is triggered, velocity timer 820 is activated, then sequential detection grid/trap logic 830 is triggered; the velocity timer 840 is readdressed, and the velocity is calculated 850 through grid distance and trigger time difference of the two detection grid/trap logics. The outcome is a visualization of the velocity on the board 860.

FIG. 9: Pilot Visual Lighting Notification System. The detection grid/trap logic 910 is triggered and consequently the pilot visual lighting 920 is activated.

Control Tower Systems:

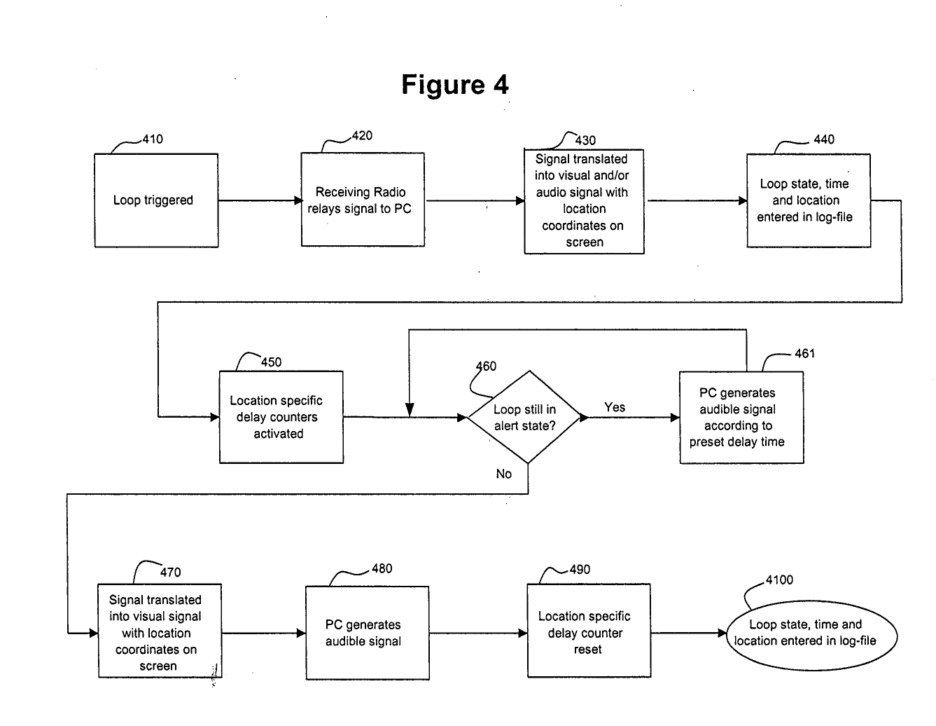

FIG. 4: Location Triggering Process. If a loop/logic module is triggered 4.10 by a target, the receiving radio relays a signal to the PC in the radio tower 4.20. The signal is translated into a visual and/or audio signal with location coordinates on the screen 430. Loop/logic module state, time, and location are entered in the log file 440. The location-specific delay counters are activated 450. If the loop/logic module is still in alert state 460, the PC generates an audible signal according to the preset delay time 461. If the loop/logic module is no longer in the alert state, the signal is translated into a visual signal with location coordinates on the screen 470. The PC generates an audible signal 4.80 and the location-specific delay counter is reset 490. The loop/logic module state, time, and location are entered in the log file 4100. FIG. 4 describes the software hierarchy, but does not describe the triggering process, which is a hardware process (See previous section).

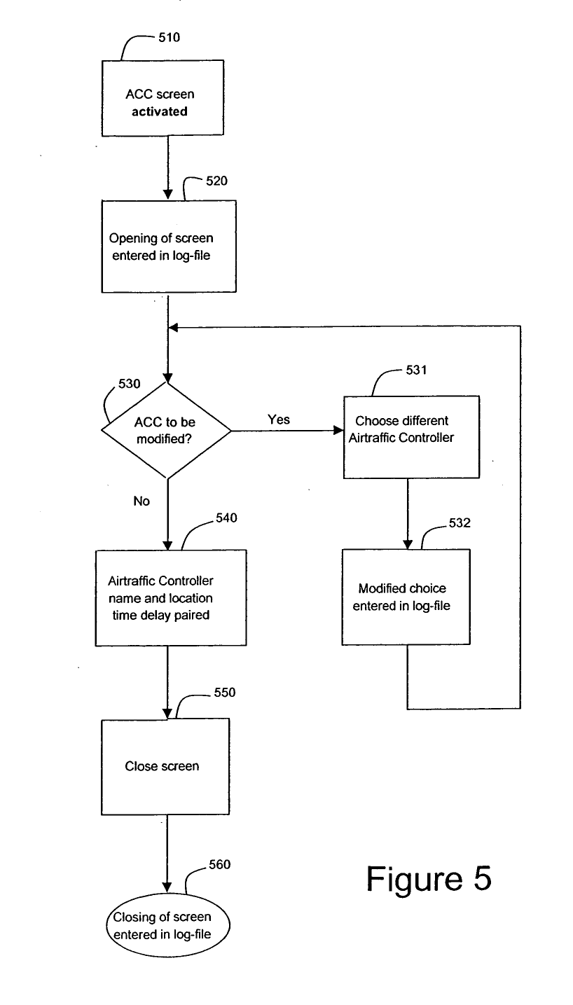

FIG. 5: Air Traffic Controller (ACC) Process. The ATC activates the ACC screen 510. The opening of the screen is entered in the log file 520. If the ATC choice needs to be modified 530, the ATC chooses a different entry 531. The modified choice is entered in the log file 532. If no additional modification is required, the ATC name and location time delay are paired 540. The ATC closes the screen 550 and the closing of the screen is entered in the log file 560.

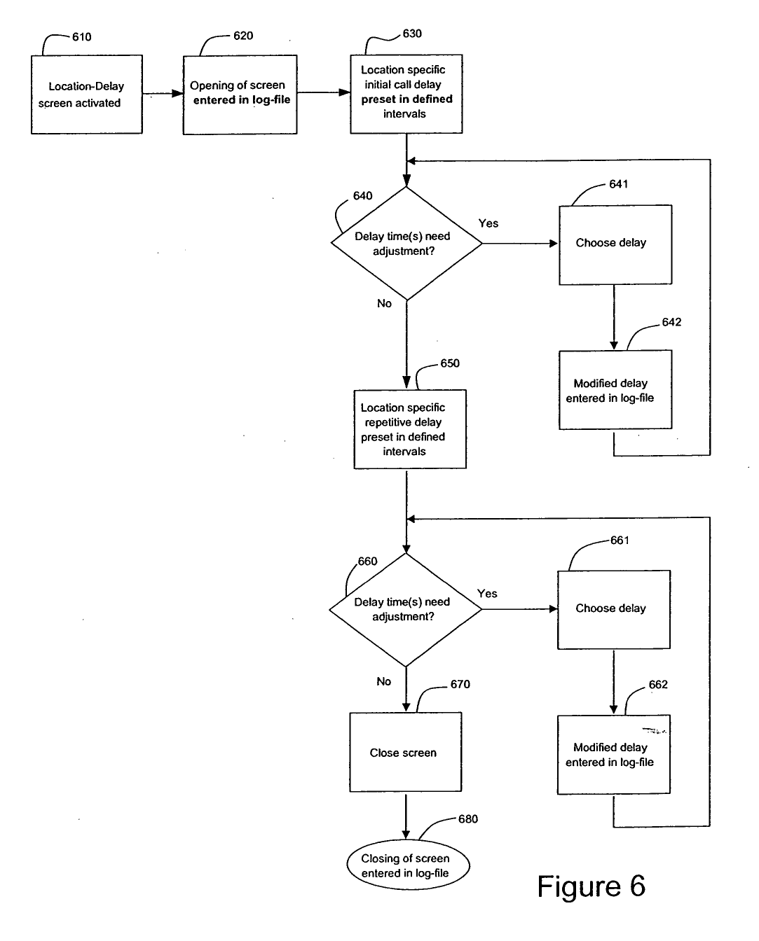

FIG. 6: Location Delay Process. The ATC activates the location delay screen 610. The opening of the screen is entered in the log file 620. The ATC can preset the location specific initial call delay in defined intervals 630. If the delay time needs to be adjusted 640, the ATC chooses the delay 641, and the modified delay is entered in the log file 642. In the next step, the location specific repetitive delay is preset in a defined interval 650. If the location specific repetitive delay time needs adjustment 660, the delay is chosen 661 and the modified delay is entered in the log file 662. If no further delay adjustment is required, the screen is closed 670 and the closing of the screen is automatically entered in the log file 680 by the software application.

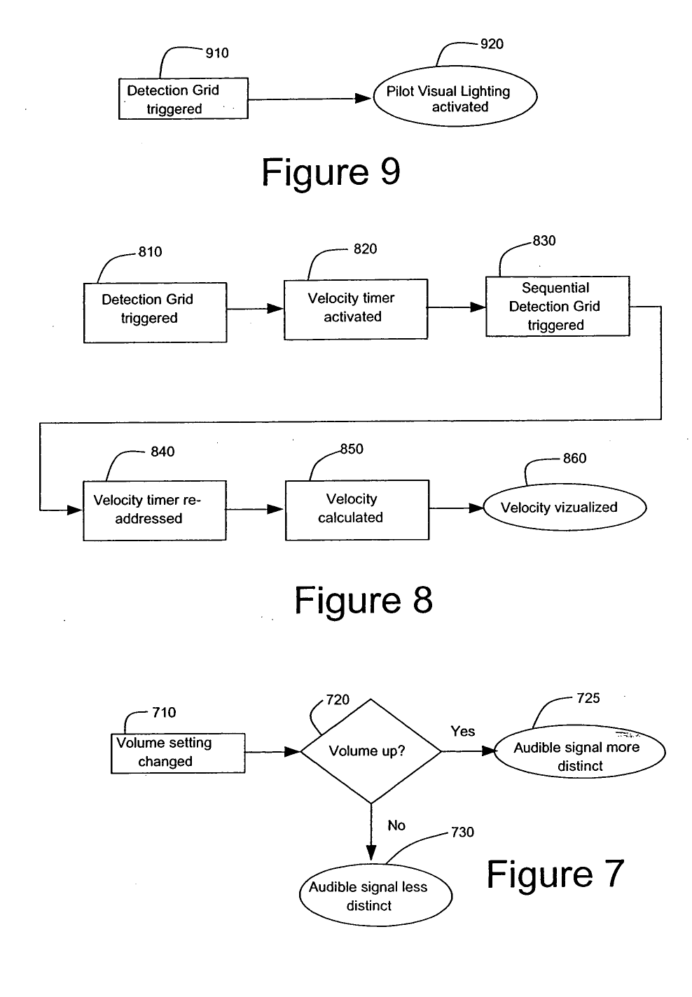

FIG. 7: Volume Regulation Process. The ATC is able to change the volume settings 710. If the ATC wants the volume increased 720, the audible signal can be more distinct 725, and if the audible signal needs to be less distinct, the volume can be need to be turned down 730.

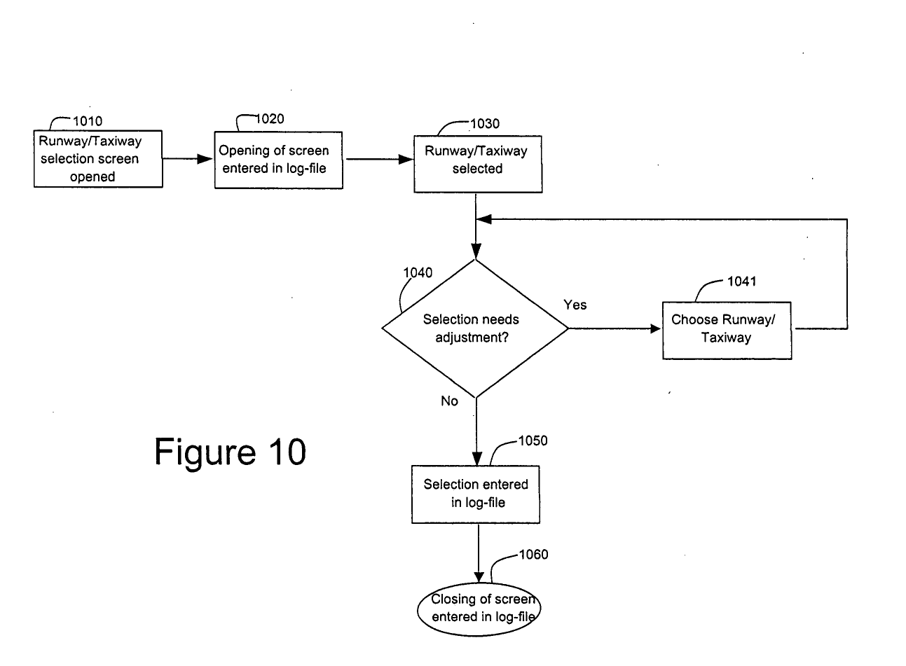

FIG. 10 illustrates a runway/taxiway selection process. The runway/taxiway selection screen is opened by the ATC 1010. The opening of the screen is entered in the log file 1020. The runway/taxiway is selected 1030. If the selection needs adjustment 1040, the ATC chooses a different runway/taxiway. If there are no additional selection adjustments, the selection is entered in the log file 1050, and upon closing of the screen, this action is entered in the log file 1060.

FIG. 11 shows a buried cable structure that is covered by a filler material, such as an epoxy. The cable includes an outer polypropylene braided, high pressure, high temperature, flexible conduit 1102. Preferably, the conduit has an O.D. of about 9.5 mm but an O.D. of up to about 16 mm can be used. It is rated at 1,400 psi/9,600 kPa burst strength. The cable free space in the conduit is entirely filled with a flexible rubber emulsion 1108 such as styrene, ethylbutylene styrene (SEBS) emulsion, or an equivalent material. The wire 1104 is polytetrafluoroethylene jacketed 1106, and silver coated, stranded, single conductor wire. The wire 1104 preferably, has a minimum of four turns, and is preferably 20 gauge, stranded, single conductor wire.

FIG. 13 show a rectangular inductive loop 1300 having a polyethylene “T” connector 1302. Preferably, the connector includes means for expansion and contraction.

Signal Relay Station Subsystem

The signal relay station is the client or agent component in this client/server application. It is the responsibility of this subsystem to monitor the analog voltage leads for the required voltage state changes coming from one or more of the magnetic field loop sensors and generating a message which is sent to the management control station.

Additionally, the agent responds to messages from the management control station on a regular basis, as the heartbeat pulse message. This is the only way for the management control station to know if one or more signal relay stations are experiencing a problem. After receiving a message from the management control station, the agent will respond with a reply message to the management control station. This is to ensure the signal relay station is functioning properly and is active and to measure the round trip message delay between the agent and the management control station. A negative reply to a message or series of messages will place all field loops monitored by that signal relay station in an alarm condition. The exact time lapse between the first missed message and subsequent messages being generated is instantaneous and is continuously being monitored.

The state change in the indicated magnetic field loop sensor is one of being high or low indication. Ideally, three states are needed: high, low and failsafe. For fault tolerance in this mission critical application, it is proposed that an active high indicates that the sensor does not detect a presence, and low indicates a positive presence by the field. The failsafe state indicates an error condition between the magnetic field loop sensor or wiring connecting to the signal relay station.

The primary reason for using this model is to ensure safety in the event of a major power disruption or a line break affecting one or more of the magnetic field loop sensors. If power is lost to any of the magnetic field loop sensors, both the management control system and the signal relay station can indicate the presence of a target in the field.

Communications Subsystem

The communication within the system can be either land line or wireless. The location of the signal relay station relative to the management control station has a distance limitation of 20 km as defined by the ISO/IEEE 802.3 standards. This distance can be extended if needed, but if extended, adds additional complexity and reliability issues. For safety reasons, it is preferable that this environment is not a routed network topology or connected to any other network, but rather is a dedicated signal relay message pipe for the heartbeat messages between the signal relay station and the management control station.

Management Control Subsystem

The management control subsystem contains the software system that monitors and displays the state indication coming from each of the individual loop systems as well as monitors the health and functionality of the entire system.

The primary function of the software is to present a visual and/or audible indication of the airport layout, with icons on the display screen indicating the location of each field loop sensor within the system. In the presence of a target in the hold short or runway zone, the icons will go into an alert status; in the absence of an obstruction, the signal is translated into a visual signal with location coordinates on the screen. In the absence of an obstruction, the icons will indicate an all-clear status.” The audible alarm, if used, clears when the obstruction leaves the area or the operator acknowledges the alarm.

In the preferred embodiment, there are two types of audible time delays: initial and repetitive. The initial time delay feature allows the controller to define the timing of the audible alarm once the zone is first triggered. These time delays range between 0 (immediate audible notification) and 60 (1-minute delay before audible notification) seconds. A O-second time delay is desirable when traffic is slow to moderate. On the other extreme, a 60-second time delay is desirable during a departure “push,” to minimize repetitive alarms when the controller already is focused on that busy intersection, and would only need an audible alarm should a distraction occur.

The repetitive delay controls the timing sequence of the audible alarms that follow the initial alert. These can also be set according to controller's preference, and most likely based on traffic levels and operational needs.

### EXAMPLE

Initial alert is set to 10 seconds and repetitive alert set to 30 seconds. Target breaches loop 1 at hold short zone;
Visual trigger immediately activated with pulsing yellow icon;
Audible alarm sounds 10 seconds after trigger;
Repetitive alarm sounds 40 seconds after trigger and repeats at 30-second intervals until target clears zone.
   Note: Both visual and audible alerts de-activate when exit trigger is breached.

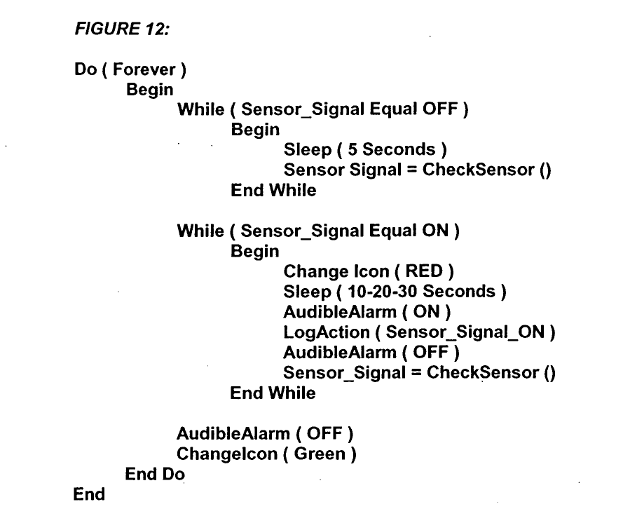

An example of the pseudo-code to complete this monitoring process is illustrated in FIG. 12, although other code sequences can be used.

The controller also will have the capability to temporarily turn off all audible alerts with a “mute” button. However, to safeguard against distraction and forgetfulness, the mute feature is deactivated automatically after 30 seconds to serve as a safeguard. Only actions that are implemented via the GUI will be logged—not via external computer hardware adjustments. Therefore, volume adjustments made by turning volume knob on monitor will not be logged.

A second function of the software is to monitor the health of the communications link to the signal relay station and of the signal relay station itself. To perform this function, the management control station will send control messages to the signal relay situation at predetermined intervals. These messages can be a specific request for a response from the signal relay station, querying the system as to the status of sensor components. The returned information is compared to the current states available in the management control station. In addition to the request to and response from the signal relay station, the management control subsystem also monitors the transmission time of each communication as well as the time lapse between each communication. In this way, any change, such as a delay in communication can be taken as a warning of possible problems within the system. If a message response time is greater than a preprogrammed length of time, the system will generate an alarm. The MCS is polling the SRS. The MCS only responds to message sent by the SRS and cannot initiate the signal.

It will be appreciated by those of ordinary skill in the art that the invention as claimed is not restricted to the particular detailed embodiments disclosed herein. Various modifications to the disclosed embodiments can be made without departing from the scope of the invention as particularly pointed out and distinctly claimed in the following claims.

What is claimed is:

1. An airfield runway occupancy warning system comprising:
a first inductive loop sensor system comprising at least one inductive loop placed in or under a taxiway at or near an entrance thereto or at or near an intersection of the taxiway and a runway, the first inductive loop sensor system generating at least one taxiway status signal when a metallic object passes over the at least one inductive loop;
a second inductive loop sensor system comprising at least one inductive loop placed in or under a runway or taxiway at or near an entrance thereto or at or near an intersection of said runway and a taxiway, the second inductive loop sensor system generating at least one runway or taxiway status signal when a metallic object passes over the at least one inductive loop;
a data collection and transmission system for receiving the runway and taxiway signals generated by any of the inductive loop sensor systems, generating data responsive to the received signals or to a combination of the received signals, and transmitting the data to at least one output system.

2. The airfield runway occupancy warning system according to claim 1, further comprising a third inductive loop sensor system, having at least one inductive loop, wherein the first, second, and third inductive loop sensor systems are placed so that a sensed object passing over the first inductive loop sensor system generates a taxiway status signal, the sensed object then passing over the second inductive loop sensor system generates a taxiway status signal and a runway alert status signal, and the sensed object then passing over the third inductive loop sensor system initiates a runway status signal.

3. The airfield runway occupancy warning system according to claim 1, wherein each of the inductive loops are substantially rectangular and are sized and placed to create a detection field sufficient to detect metallic objects passing over the runway or taxiway.

4. The airfield runway occupancy warning system according to claim 1, wherein the at least one output system comprises at least one user alert system selected from the group consisting of a monitor having a graphical user interface, an approach lighting system, and a ground alert lighting system.

5. The airfield runway occupancy warning system according to claim 1, further comprising at least one variable message board, said variable message board being positioned along a taxiway and displaying airport environmental and runway occupancy status sensor data and airport environmental sensor data, including wind speed and wind direction.

6. The airfield runway occupancy warning system according to claim 1, the first and second inductive loop sensor systems generate fields spanning the width of the runway or taxiway in which the first and second inductive loop sensor systems are respectively placed.

7. The airfield runway occupancy warning system according to claim 1, wherein said inductive loops comprise at least three twisted wires within a conduit.

8. The airfield runway occupancy warning system according to claim 7, wherein said conduit contains four twisted wires, and also contains a flexible rubber emulsion.

9. The airfield runway occupancy warning system according to claim 1, wherein each of the first inductive loops has a cross-sectional diameter of no greater than about 9.5 mm.

10. The airfield runway occupancy warning system according to claim 1, wherein each of the second inductive loops has a cross-sectional diameter of no greater than about 16 mm.

11. The airfield runway occupancy warning system according to claim 1, wherein the inductive loops placed in or under a taxiway comprise at least three twisted wires and are housed within a braided polymeric flexible conduit, the conduit containing a flexible rubber emulsion and having an outside diameter of up to about 9.5 millimeters and a minimum burst pressure of about 1,400 psi.

12. The airfield runway occupancy warning system according to claim 1, wherein the inductive loops placed in or under a runway comprise at least three twisted wires and are housed within a braided polymeric flexible conduit, the conduit containing a flexible rubber emulsion and having an outside diameter of up to about 16 millimeters and a minimum burst pressure of about 9,000.

13. The airfield runway occupancy warning system according to claim 1, wherein said data collection and transmission system comprises a control system for controlling lighting systems along said runway and providing a visual alert, to a flight crew on final approach, of potential runway obstructions through an approach lighting system.

14. The airfield runway occupancy warning system according to claim 1, further comprising a control tower and at least one monitoring device being located in the control tower, the monitoring device displaying the configuration and layout of the airport runways and taxiways.

15. The airfield runway occupancy warning system according to claim 12, wherein said flexible conduit comprises braided polypropylene and said wires have a minimum of three turns of polytetrafluoroethylene jacketed and silver coated, stranded, single conductor wire, and said rubber emulsion is a styrene ethylbutylene styrene emulsion and said inductive loops are substantially rectangular and have a polyethylene “T” connector with means for expansion and contraction.

16. The airfield runway occupancy warning system according to claim 1, further comprising an electronic loop detector for sampling the signals generated by the inductive loops, generating sampled signal data, and passing the sampled signal data to the data collection and transmission system.

17. The airfield runway occupancy warning system according to claim 1, further comprising a central processing unit for sensing a change in a resonant frequency of an inductive loop due to a decrease in inductance.

18. A method for monitoring occupancy of airfield runways and taxiways, comprising the acts of:
placing a plurality of inductive loop sensors into an airfield runway or taxiway, or both, to generate runway status signals when a metallic object passes over any of the inductive loop sensors;
sending the runway status signals to a data collection and transmission system for receiving the runway or taxiway status signals generated by the inductive loop sensors, generating occupancy data responsive to the received signals or to a combination of the received signals; and
transmitting the occupancy data to at least one output system that provides a visually or audibly perceptible signal indicating runway or taxiway occupancy.

19. The method for monitoring occupancy of airfield runways and taxiways according to claim 18, wherein the at least one output system comprises at least one runway lighting system.

20. An airfield runway occupancy warning system comprising:
first means for sensing the presence of an object on a taxiway at or near an entrance thereto or at or near an intersection of the taxiway and a runway, the first sensing means generating at least one taxiway status signal when an object is sensed;
second means for sensing the presence of an object on a runway or taxiway at or near an entrance thereto, the second sensing means generating at least one runway or taxiway status signal when an object is sensed;
a data collection and transmission system for receiving the runway and taxiway signals generated by any of the inductive loop sensor systems, generating data responsive to the received signals or to a combination of the received signals, and transmitting the data to at least one output system.
